(19) United States
(12) Patent Application Publication
(10) Pub. No.: US 2016/0059275 A1
(43) Pub. Date: Mar. 3, 2016

(54) Canned Vacuum Devices for Collecting and Storing Materials and Methods of Use

(71) Applicant: LMS Innovations, LLC, Newberry, FL (US)

(72) Inventors: Daniel Alexander Smedley, Arlington, TX (US); Kenneth Jacob Linton, Marianna, FL (US)

(21) Appl. No.: 14/838,698

(22) Filed: Aug. 28, 2015

Related U.S. Application Data
(60) Provisional application No. 62/043,531, filed on Aug. 29, 2014.

(51) Int. Cl. B08B 5/04

(52) U.S. Cl. CPC B08B 5/04

(57) ABSTRACT

A vacuum device that operates without aid of a pump. More specifically, a vacuum device that utilizes a negative pressure container capable of providing sufficient vacuum or aspiration force to collect solid, liquid, or gas material(s) and which does not require a pump to facilitate aspiration during the collection process. A valve apparatus and conduit can be operably connected to a single opening in the vacuum device. A float valve assembly within the conduit can inhibit the intake of air into the container.

### BACKGROUND OF INVENTION

The ability to collect and contain hazardous or dangerous materials or substances is a requirement in many industries. Most of the time, a multi-stage pump-driven vacuum device can be used to collect materials and store them in an attached container. There are some materials, however, that cannot be, or are not safe to be, collected with standard, motor-driven pump vacuum devices. Remote locations can be difficult to reach and certain materials are too dangerous or toxic to be collected with pump-driven vacuum, which usually require an exhaust port.

In the petroleum industry, it is often necessary to clean-up and store petroleum products, such as gasoline and oil, which has been spilled or accidentally released into the environment. One example of this type of “environmental remediation” occurs with the use of underground storage tanks (UST) for petroleum products. When filling a UST, a hose is typically attached to a connector on the UST and gas or oil is then gravity fed into the UST. When the UST is full, a valve is used to close the hose prior to it being removed from the UST connector. There is usually some amount of the petroleum product left in the hose that will spill out when the UST connector is removed, often draining into a sump that can temporarily contain the spillage. It then becomes necessary to collect the spilled material from the sump.

The volatility of petroleum products can make remediation dangerous with electrical or motor-driven vacuum devices, where a spark could ignite the product. Further, the locations where many USTs are located are too remote for standard vacuum devices to be useful. It may also be necessary to collect spilled material around numerous USTs, which makes transport and set-up of typical, motor-driven vacuum devices time-consuming and impractical.

While these disadvantages with typical pump-driven vacuums are particularly problematic in the petroleum industry, they can also be problematic in other industries. The exhaust created by typical pump-driven vacuums may not be practical or safe in some medical and laboratory facilities. Remote or difficult to reach areas, such as ship bilges, septic tanks, and other areas where toxic substances can collect and need to be remediated can also be difficult to reach with typical pump-driven vacuum devices.

### BRIEF SUMMARY

Embodiments of the subject invention successfully address the disadvantages associated with previously known pump-driven or electrically powered vacuum devices and methods, particularly for remediation of hazardous or dangerous materials, such as petroleum or medical waste products. Embodiments described herein provide certain attributes and advantages, which have not been provided by the previously known devices. In particular, the embodiments of the subject invention provide novel, highly effective devices and methods for convenient and safe remediation of hazardous materials, such as, for example, petroleum, chemical, biological, or medical waste materials.

In accordance with embodiments of the subject invention, the problem of collecting and storing hazardous materials, particularly highly volatile or flammable materials, or materials in remote or at least difficult to reach locations is solved by the use of a negative pressure container that can be used effectively without the aid of an operating pump, can store a negative vacuum pressure for a period of time, and can retain the negative vacuum pressure level in the container. Such “canned vacuum” devices can have numerous uses and can be reusable or disposable, as necessary.

Advantageously, the container embodiments of the subject invention can achieve significant vacuum force, can be portable, quiet, easy to operate, and can use, though do not require, only a single opening for all operations, reducing possible avenues of material loss. Other embodiments include the ability to recharge a container if the negative pressure therein is released or lost, such as when the device is emptied or when too much air or other gas is taken into the device. Additional embodiments can include convenient dual-valve operation, and interchangeability of intake conduits without loss of negative pressure. Still other embodiments can have a single-valve operation.

Other embodiments include a pump integrated with the devices that can be used to recharge the negative pressure in the container, when the negative pressure in the container is low or has run out. For the purposes of evacuating a container, according to the subject invention, there are any of a variety pumps that can be used. For example, standard, multi-stage, electric pumps that can be used, as well as other types of electric pumps, in addition to numerous types of venturi pumps that utilize air or water to evacuate the air or gas from a container of the subject invention. Typically, embodiments of a canned vacuum container of the subject invention are evacuated or “charged,” prior to use, by attaching a pump, directly or indirectly, to the container, activating the pump with an appropriate type of operational energy (e.g., pressurized air, AC or DC electricity, pressurized water, solar cells, etc.) and evacuating the air to achieve an appropriate negative pressure level. This can create negative pressure or a “canned vacuum” in the container, whereby opening the container creates a vacuum pressure or suction force through an opening as air rushes back into the container.

A particular embodiment employs a venturi pump attached to the container for recharging the negative pressure in the container. The vacuum pressure generated by the container can be dictated by several factors, with one of the most important being the level of negative pressure in the container. Containers used with the embodiments of the subject invention can achieve up to a full one atmosphere of negative pressure, and, when utilized with any of various valve devices can maintain the negative pressure in the container to at or about that level until the container is full.

Specific embodiments can utilize a valve closure with an on/off control on the container opening to which a conduit coupling, for example, a hose coupling or other conduit coupling device, can be attached. The coupling can be removed for attachment of a pump onto the valve closure to evacuate the container and achieve negative pressure therein. Alternatively, a pump connector can be utilized between the valve closure and the coupling such that the coupling does not have to be removed when using a pump to evacuate the container.

In a particular embodiment, a venturi pump device is disposed between the valve closure and the coupling. Venturi pump devices are known in the art and can be beneficially used with embodiments of the subject invention. These types of pneumatic pumps can operate with few or no moving parts and can also be more powerful than standard electric pumps. In many field situations or remote locations, a forced air pump is often available or can be obtained, such as those found at most gas service stations, more readily than a pump capable of evacuating air directly from the container. Operation of a venturi pump to recharge a container of the subject invention can be more feasible in some locations or situations. The use of such pumps can also be safer if a container of the subject invention is utilized for volatile petroleum products.

One particular embodiment employs a pump, such as, for example, a venturi pump, stored in a chamber or other separate space on the tank. This can allow the tank to be used in any locale and, when possible or convenient, the pump, stored in the chamber, can be conveniently utilized to restore negative pressure in the tank. Thus, if during use the negative pressure is lost before the tank is full, the pump can be used to restore the negative pressure in the tank, allowing the tank to continue being used until full. Further, enclosing the pump in a chamber or space that is attached to the tank reduces or inhibits the likelihood of the pump igniting or otherwise affecting volatile materials in the tank.

Intake or aspiration of material into the container can be achieved with some type of conduit. In one embodiment, such a conduit is a hose or tubing of a predetermined length attached to the coupling and/or the valve closure and used to contact or permit the suction force to contact the material to be collected. The hose can also have one or more control mechanisms that at least allow the hose to be opened and closed, conserving the negative pressure in the container and mediating the vacuum pressure. The hose can also include mechanisms or apparatuses for keeping the hose closed except when the hose tip is in contact with a material to be aspirated. One particular embodiment utilizes a specific gravity float at the hose tip that permits intake of a specific type of liquid, such as, for example, gasoline or oils, and closes the hose when water, air, or other materials are encountered by the float. Other embodiments can utilize a depression valve or button in the hose tip that can be depressed or released when the hose tip is in contact with a material to be aspirated. In a particular embodiment, a spring-biased button is fit into the hose tip to keep the hose tip closed, until or unless the button is depressed into the hose tip, thereby opening one or more channels for aspiration of material. In another embodiment, a conduit is a hopper having an opening that can be operably connected to the coupling or the valve closure. Material can be loaded into the hopper and the valve closure can be opened so that the material is aspirated into the container from the hopper.

The devices of the subject invention can be advantageously used for the collection of a variety of substances or materials. They can be used in a variety of locales where it is not possible or practical to use typical electrical and/or pump-driven vacuums. The devices of the subject invention can be made to any size or specification necessary for a particular use.

It should be noted that this Brief Summary is provided to generally introduce the reader to one or more select concepts described below in the Detailed Disclosure in a simplified form. This Summary is not intended to identify key and/or required features of the claimed subject matter. Other aspects and further scope of applicability of the present invention will also become apparent from the detailed descriptions given herein. It should be understood, however, that the detailed descriptions, while indicating preferred embodiments of the invention, are given by way of illustration only, since various changes and modifications within the spirit and scope of the invention will become apparent from such descriptions. The invention is defined by the claims below.

### BRIEF DESCRIPTION OF DRAWINGS

In order that a more precise understanding of the above recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1 is an illustration of an embodiment of a canned vacuum device, according to the subject invention.

FIG. 2 is an illustration of an alternative embodiment of a canned vacuum device, according to the subject invention.

FIG. 3 is an illustration of still another alternative embodiment of a canned vacuum device, according to the subject invention.

FIG. 4A is an illustration of an embodiment of a canned vacuum device, according to the subject invention, having a pump stored within a compartment in the container.

FIGS. 4B, 4C, 4D, and 4E illustrate an alternative embodiment of a canned vacuum device, according to the subject invention, having a dedicated pump storage compartment in the distal or bottom end of the container for storing a pump, where the container further has a pump channel incorporated therein that connects the pump, in the storage compartment, to the container interior to remove air and create negative pressure.

FIG. 5 is an illustration of an embodiment of a canned vacuum device, according to the subject invention, wherein the conduit has been removed for attachment of a pump.

FIG. 6A is an illustration of an embodiment of a float valve apparatus, according to the subject invention, within a hose tip.

FIG. 6B is an illustration of an alternative embodiment of a float valve apparatus, according to the subject invention, with a spring-bias device.

FIG. 7A is an illustration of a venturi pump attached to the valve apparatus of an embodiment of the canned vacuum device, according to the subject invention.

FIG. 7B is an illustration of an alternative embodiment of a venturi pump integrated into the intake assembly, between the valve apparatus and the conduit.

FIG. 7C is an illustration of still another alternative embodiment of a venturi pump integrated into the intake assembly, between the container and the valve apparatus.

FIG. 8 is a photograph of one embodiment of a vacuum device according to the subject invention.

FIG. 9 is a photograph of an embodiment of a vacuum device according to the subject invention. In particular, there is shown a connector at the distal end that leads into a storage compartment on the distal end of the container.

FIG. 10 is a photograph of an embodiment of a vacuum device according to the subject invention, where the bottom distal end has been removed to show the interior of the storage compartment. It can be seen in this embodiment that a venturi pump is affixed to a connector for taking in compressed air and the evacuation channel exiting into the storage compartment and attached to the venturi pump.

FIGS. 11A and 11B illustrate yet another embodiment showing an alternative configuration for a vent and evacuation channel.

### DETAILED DISCLOSURE

The subject invention describes embodiments of vacuum devices that can operate without the direct aid of a pump. More specifically, the subject invention provides one or more embodiment(s) of negative pressure containers capable of providing sufficient vacuum or aspiration pressure to collect solid, liquid, or gas material(s) and which does not require a pump to facilitate such aspiration during the collection process. As will be discussed in detail below, the negative pressure in a canned vacuum device of the subject invention can be achieved with any of a variety of pumps and, once activated, a canned vacuum device of the subject invention can operate to collect material without the aid of a pump. Thus, the pump can be turned off, disengaged, or otherwise deactivated during the process of actual aspiration or collection of material into the container.

The following description will disclose that the subject invention is particularly useful in the field of environmental remediation, in particular, environments that may be remote or otherwise difficult to reach, or where it may be impractical to utilize pump-driven vacuum devices. However, a person with skill in the art will be able to recognize numerous other uses that would be applicable to the devices and methods of the subject invention. While the subject application describes, and many of the terms herein relate to, a use for collecting volatile or hazardous liquids, other modifications apparent to a person with skill in the art and having benefit of the subject disclosure are contemplated to be within the scope of the present invention.

In the description that follows, a number of terms pertaining to the embodiments of the subject invention are utilized. In order to provide a clear and consistent understanding of the specification and claims, including the scope to be given such terms, the following definitions are provided.

The term “technician” as used herein is merely for literary convenience. This term should not be construed as implying or limiting in any way the skill of a person capable of using the embodiments of the subject invention. The devices, apparatuses, methods, techniques, and/or procedures of the subject invention could be utilized by any person desiring or needing to do so and having the necessary skill and understanding of the invention.

The term “material” as used herein is also for literary convenience and should not be construed as limiting in any way. The embodiments disclosed herein can be used to collect, contain, store, and dispense any solid, liquid, gas, or combination thereof, to which the devices have been adapted for use. They can also be used with biological or non-biological organisms or materials. The embodiments described herein can be particularly amenable for use with liquid materials. This does not, however, preclude their being used with other non-liquid materials. Variations of the disclosed embodiments that permit use with materials other than liquids are within the scope of this invention.

Also, as used herein, and unless otherwise specifically stated, the terms “operable communication,” “operable connection,” “operably connected,” “cooperatively engaged,” and grammatical variations thereof mean that the particular elements are connected in such a way that they cooperate to achieve their intended function or functions. The “connection” or “engagement” may be direct or indirect, physical or remote.

Finally, reference is made throughout the application to the “proximal end” and “distal end,” of a container and a conduit. As used herein, the container proximal end is that end that is furthest from the ground when the device is placed in an upright position or that end which material moves away from when taken into the container or that end of the container at or about where material being collected enters the device. Conversely, the distal end of the container is that end placed against the ground or other surface when the device situated in an upright position or, said otherwise, the end against which collected material is directed, can gather or be compiled. The distal end is typically directly, or approximately directly, opposite to the proximal end.

The present invention is more particularly described in the following embodiments and examples that are intended to be illustrative only, since numerous modifications and variations therein will be apparent to those skilled in the art. As used in the specification and in the claims, the singular for “a,” “an,” and “the” include plural referents unless the context clearly dictates otherwise.

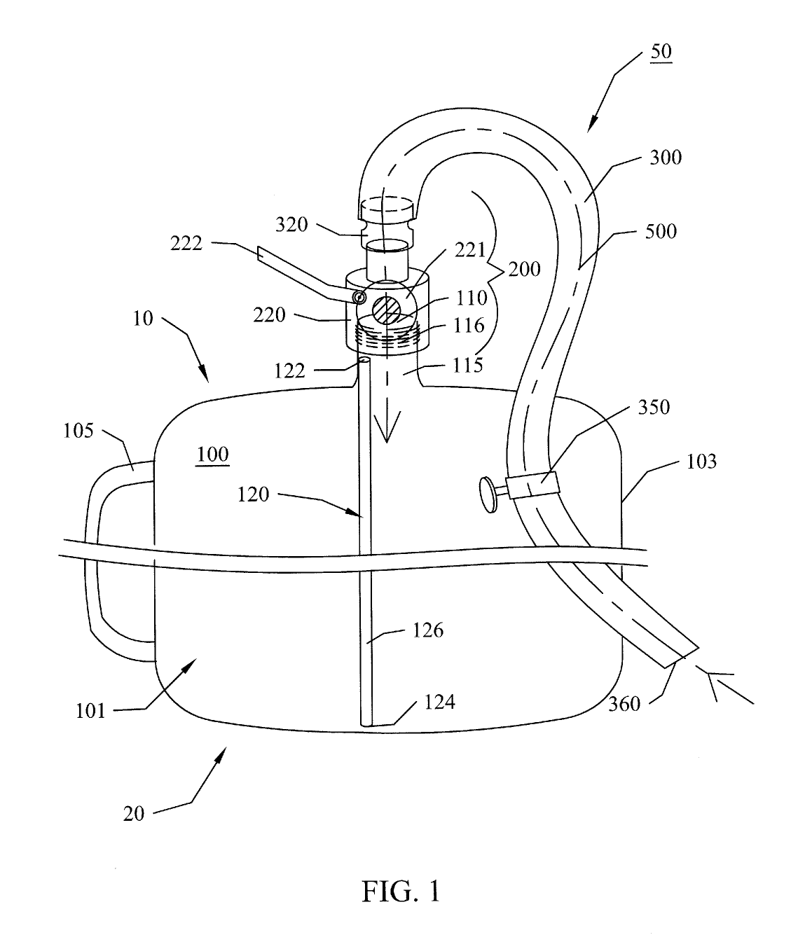

Reference will be made to the attached figures on which the same reference numerals are used throughout to indicate the same or similar components. With reference to the attached figures, which show certain embodiments of the subject invention, it can be seen in FIG. 1 that a “canned vacuum device” 50 of the subject invention comprises a container 100 having a proximal end 10, where material is taken into the container, and a distal end 20, an intake assembly 200, and a conduit 300. Alternative embodiments, can include a dedicated compartment for storing 150 for storing a pump 600 incorporated with the canned vacuum device that can be utilized to obtain or create a negative pressure in the container. Each of these general components can have one or more alternatives or sub-components, which will be discussed in detail below.

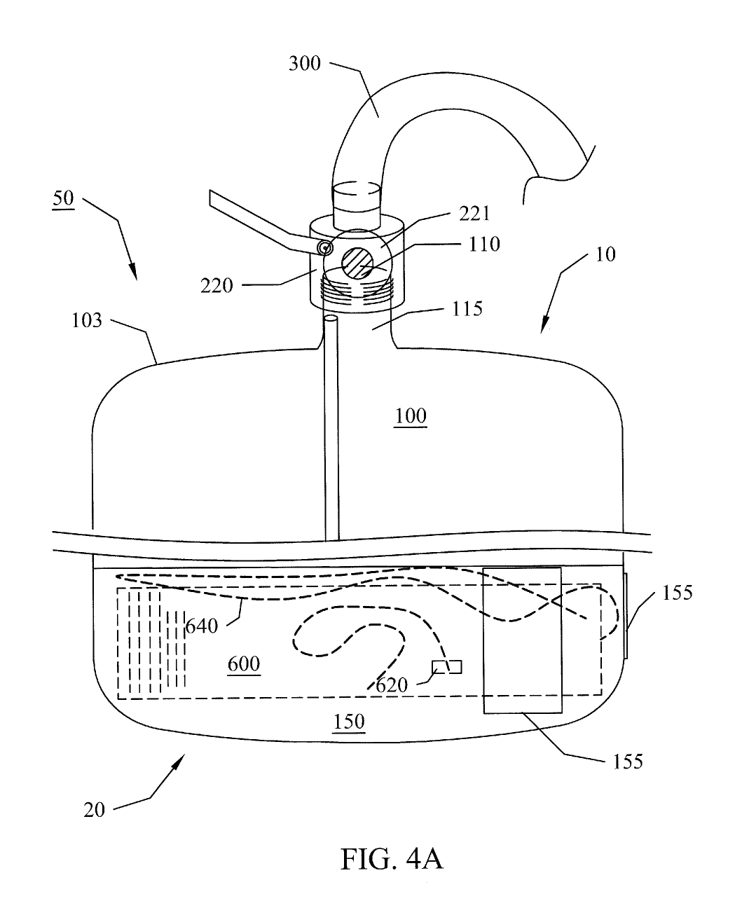

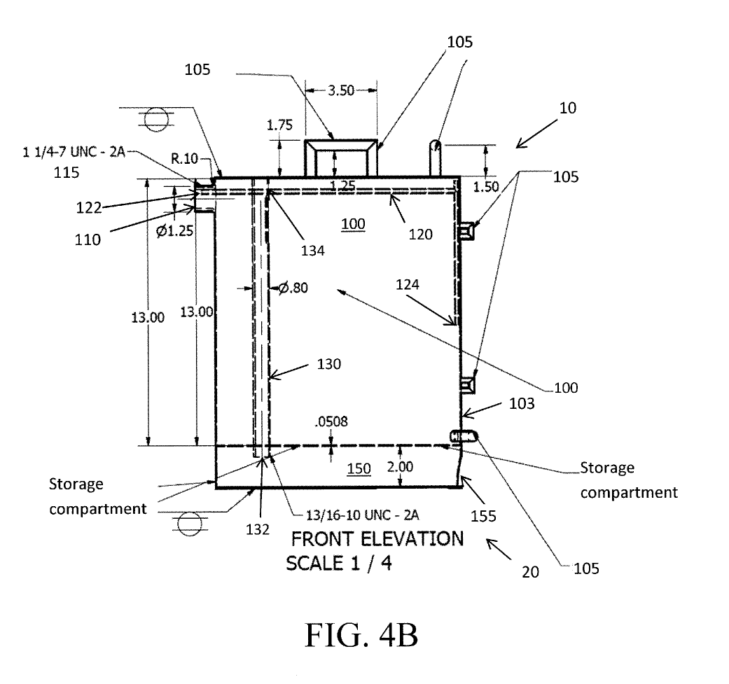

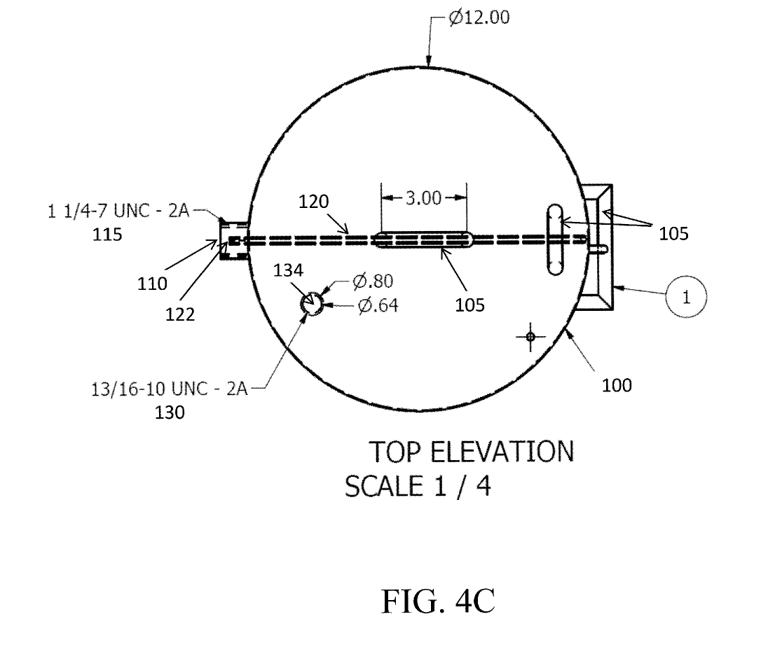

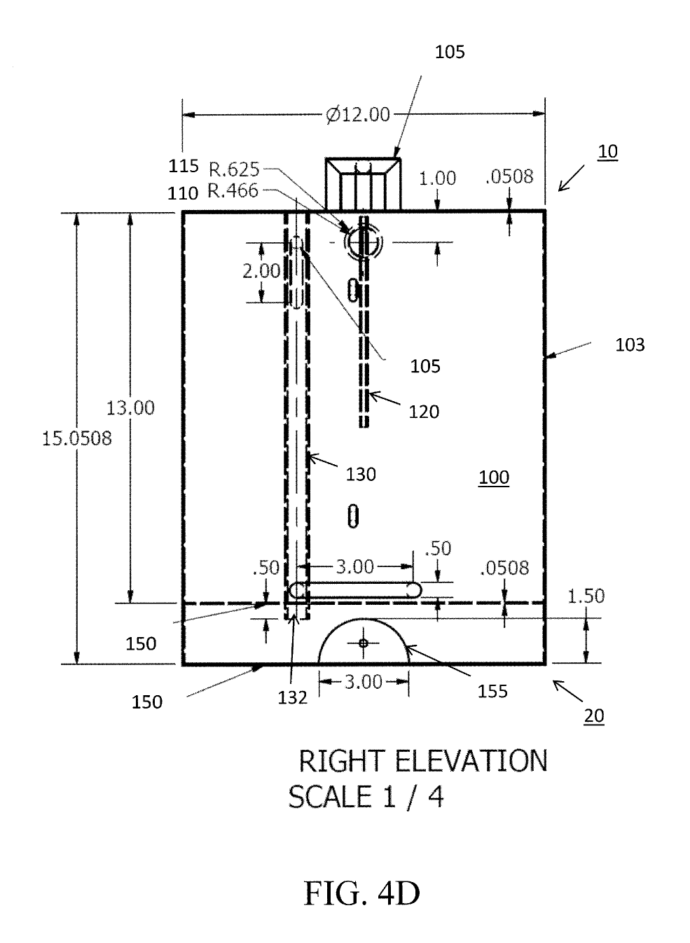

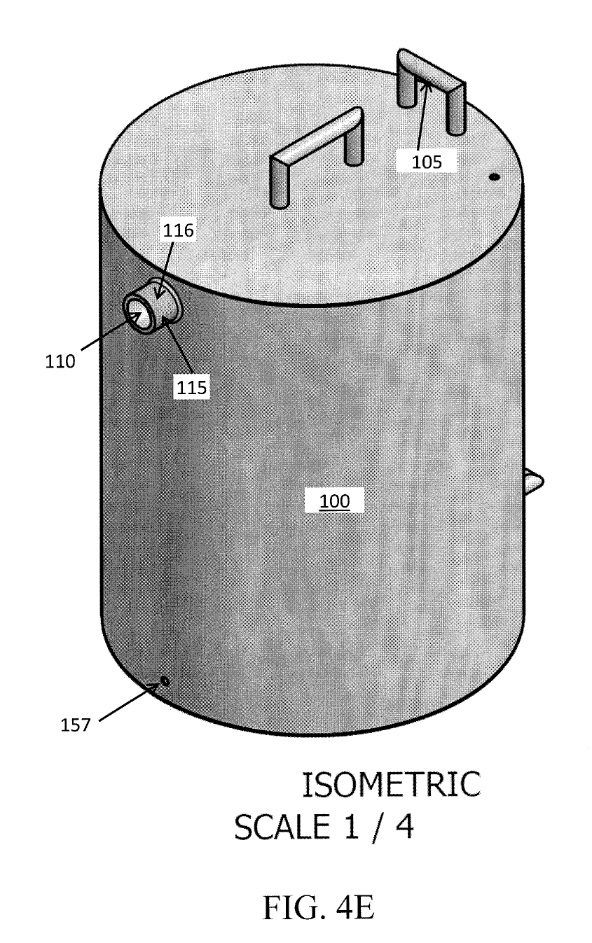

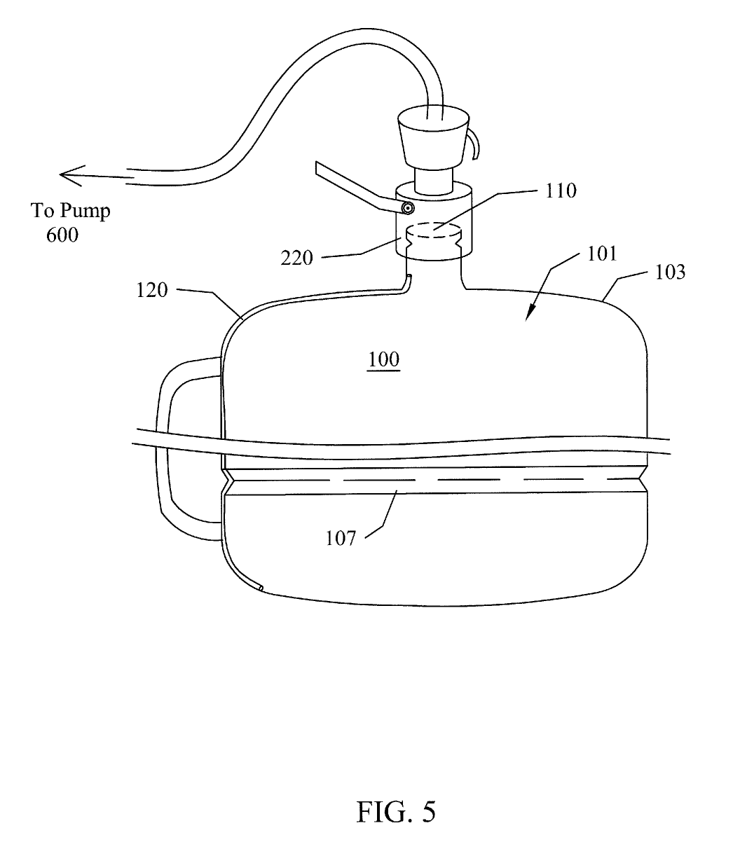

With regard to container embodiments of the subject invention, there is a plurality of container styles, sizes, and configurations that can be used with the subject invention. FIGS. 1 and 4A illustrate embodiments of portable canister style containers that can be used. The portable canister embodiments can be carried by a technician, for example, by using an attached handle 105, to different sites for remediation of small amounts of material. Other embodiments can employ larger containers, such as those that can be rolled on wheels or hand-carts or those that are carried on a truck or other vehicle. In one embodiment, a container of the subject invention has sufficient rigidity to maintain a full one atmosphere of negative pressure therein. Any of a variety of materials can be used for a container, including, but not limited to, glass, metal, ceramics, plastics, or combinations thereof. In one embodiment, a container is entirely rigid such that it holds its shape regardless of the level of negative pressure or any material therein. In an alternative embodiment, a container is only partially rigid, such that portions thereof can be contracted, expanded, or otherwise deformed depending upon the amount of negative pressure and/or material therein. One embodiment shown, for example, in FIG. 5 utilizes a container with one or more collapsible bellows 107 that allow the container to at least partially expand or contract. A person with skill in the art will be able to determine an appropriate size, shape, configuration and material for a container, according to the intended use and material(s) to be remediated with the device, according to the subject invention. Such variations are within the scope of this invention.

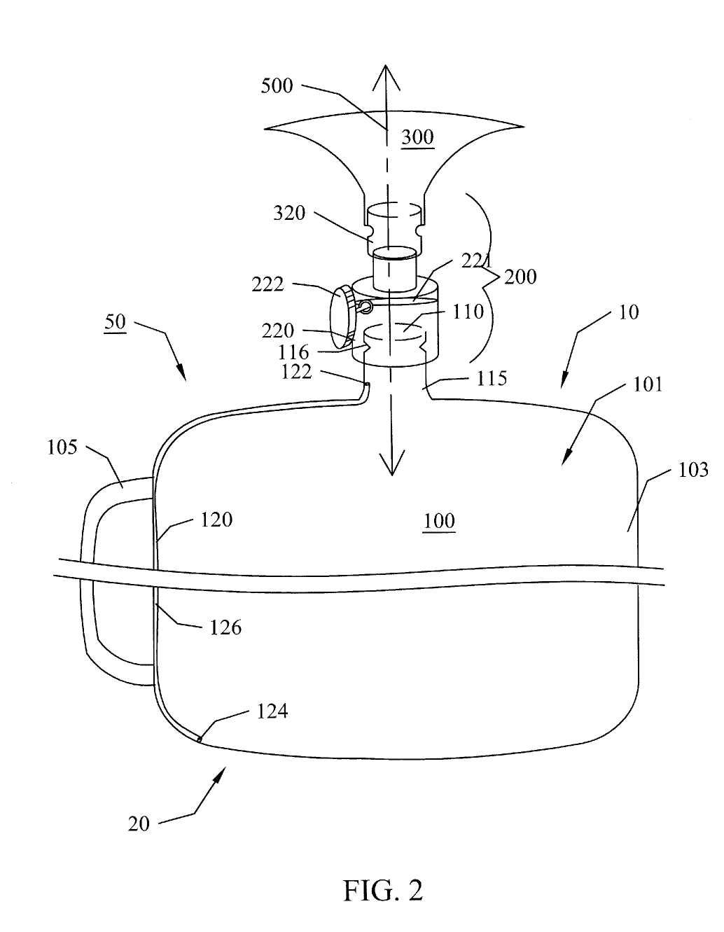

A container 100 can have as many openings or intakes 110 as desired or necessary for a particular purpose. However, for certain materials, such as hazardous chemicals or bio-hazardous organisms, it can be necessary or at least desirable to minimize the opportunities for release or escape by minimizing the number of intakes in a container. The canned vacuum devices 50 of the subject invention have the advantage of not creating exhaust and are capable of being completely operational with a single intake 110 to which an intake assembly 200, discussed below, can be operatively connected. One embodiment of the subject invention utilizes a container 100 having a single intake 110 to which an intake assembly 200 can be securely and operatively attached. The single intake can be located anywhere in a container, as long as such location does not prevent or inhibit the collection or storage of a material. For example, a canned vacuum device used for collecting a liquid can operate more effectively if the intake is positioned at or about the proximal end 10 of the container, as shown, by way of example, in FIG. 1. The single intake can be located on the proximal end or the top of the container, as shown in FIGS. 1 and 2. Alternatively, the single intake can be in a side of the container, and at least at or near the proximal end of the container, as shown, for example, in FIGS. 4B-4E. Liquid collected in the container will accumulate at the distal end 20, away from the intake 110, so that it is prevented or inhibited from blocking the intake or backing up into the conduit 300 that may be attached to the intake.

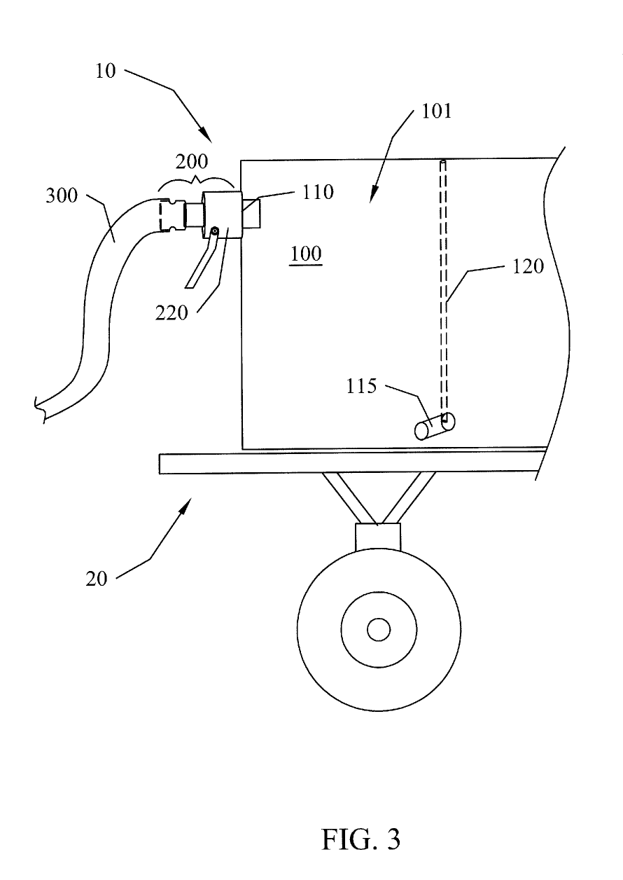

The intake assembly 200, as discussed below, can be attached to the intake. One or more components of the intake assembly, or the entire intake assembly, can be removed from the intake to allow for emptying of the container or access to the interior 101. The design of the intake can dictate the configuration of the intake assembly. In one embodiment, the intake is flush with the wall 103 of a container. With this embodiment, some part of the intake assembly 200 would fit into the intake 110 and, in some instances, can be permanently attached to the intake. FIG. 3 illustrates one example of a large, truck-mounted container, according to the subject invention, where the intake assembly 200 is attached to a flush intake. FIG. 3 also illustrates an example of a container having more than one opening, where the intake assembly is attached to one proximal end 10 intake and another more distal end intake can be used to evacuate the container. When the intake assembly and conduit are attached to a container, there is formed a contiguous channel that leads into the container interior 101.

In an alternative embodiment, an intake has a neck 115 that protrudes from the container and is, at least partially, contiguous with the intake, examples of which are shown in FIGS. 1, 2, the lower intake in FIG. 3, and FIGS. 4B-4E. A neck can be used as a connection point for an intake assembly or, conversely, for the direct attachment of a conduit 300. In one embodiment, the neck 115 has connecting structures 116 that aid in permanently or removably attaching a conduit or an intake assembly. Connecting structures on the neck that can be employed with embodiments of the subject invention can include, but are not limited to, indentations, continuous or discontinuous threading, extended surface features, or combinations thereof, to which an intake assembly can be operably connected. These connecting structures can be used with any of a variety of devices to connect the conduit to the intake.

Once material has been collected in a container 100, the material can be properly disposed of or stored. A container can be adapted with appropriate materials and/or configuration to store a material for any pre-determined amount of time, from indefinitely to a few minutes or hours. If the container is intended to be emptied after use or when full, one or more intakes, as mentioned above can be used. The intake assembly 200 can include an apparatus that will permit ambient atmosphere into the container, deactivating any remaining negative pressure. In an exemplary embodiment, the intake assembly can be removed from a single intake in the container allowing the container to be emptied from the single intake. Alternatively, another intake can be used to empty the container.

It will be appreciated by those skilled in the art that when emptying liquid or viscous materials it is desirable to minimize splashing or bubbling during the pouring process, especially if such materials are in any way hazardous. In one embodiment, a container can include a vent 120 in operable communication with the intake, such that liquid in the container can be emptied more easily and with less splashing or gurgling. This can be particularly helpful if the container has only a single intake and/or the diameter of the intake is such that the container cannot be emptied in a smooth flow.

Vented containers are known in the art and allow air to enter a container as liquid exits to prevent back-pressure, which is the cause of the splashing and gurgling that often accompanies emptying of unvented containers. However, a negative pressure container with a built-in vent to inhibit splashing or gurgling when the container is emptied and that is not removed from the container is unique. In one embodiment, the vent is an elongated tubular structure with a first opening 122 that is contiguous with and removably or fixedly attached to the intake and a second opening 124 further within the container interior 101, for example, at or near to or at least directed towards the distal end of the container or at least a sufficient distance from the intake. The vent can be a closed tubular channel 126. FIG. 1 illustrates an example of a vent that extends through the interior 101 of the container.

FIG. 2 illustrates an example of a vent incorporated with, or at least in proximity to, a wall 103 of the container. While the vent can follow the shape of the container interior, this is not required. With this embodiment, the first opening 122 is positioned at or near the intake and the second opening is at or near to the distal end of the container. The intake assembly and/or conduit can be completely removed from the container and the vent remains in place to aid in dispensing, with minimal splashing, material therein.

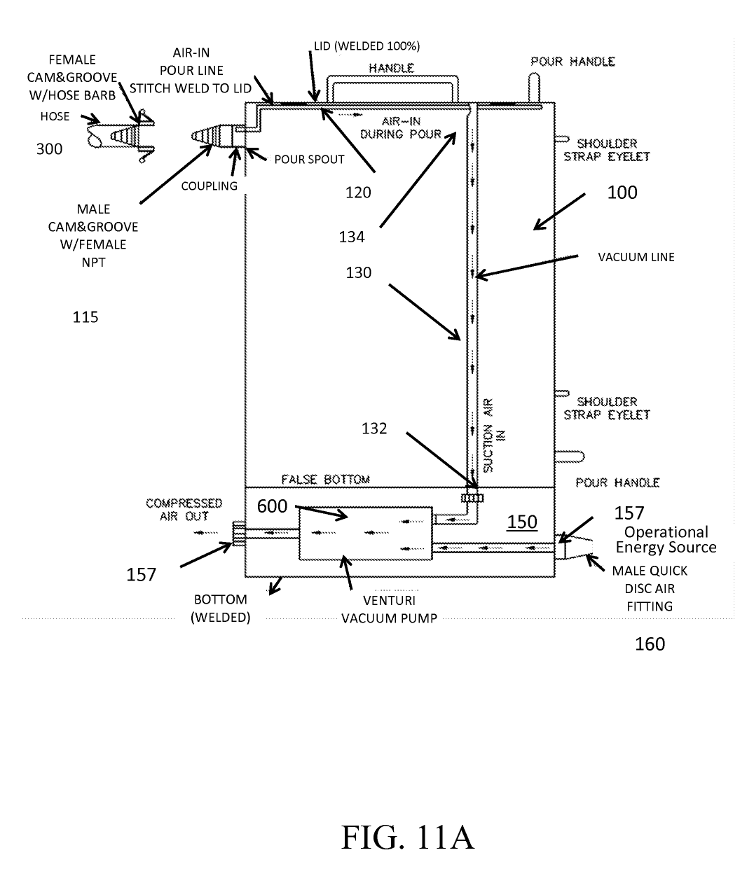

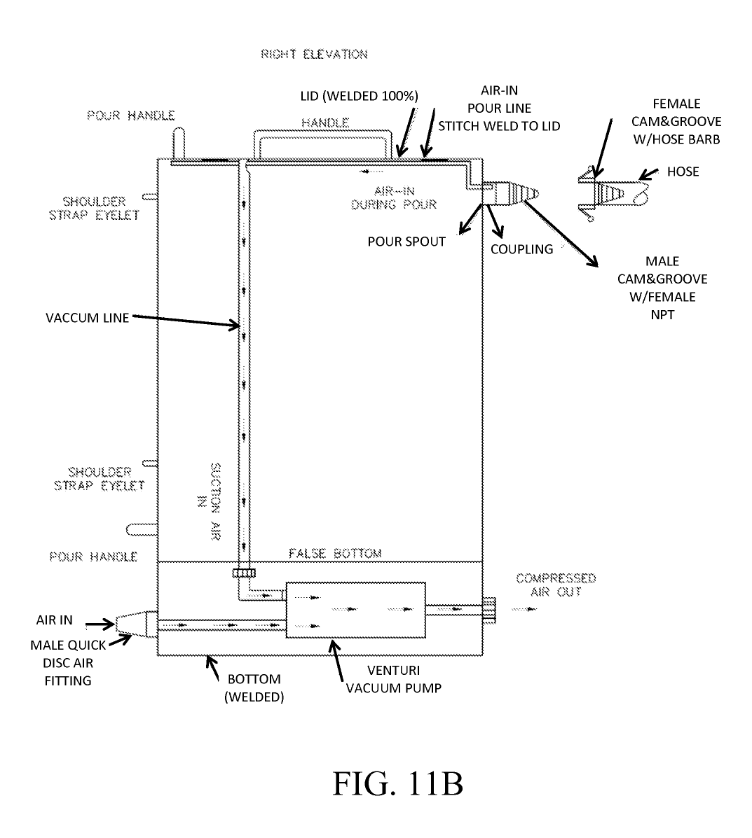

For example, FIG. 2 illustrates an embodiment where the handle and the first end 122 of the vent are on, or at about, the same side of the container. This can ensure that when the handle is used to tip the container, the material being dispensed does not interfere with the operation of the vent. FIG. 4B illustrates yet another embodiment where part of the vent is incorporated or at least attached to the interior wall 103 of the container and another portion is unattached and, in a particular embodiment, extends across the proximal end of the container interior. FIGS. 11A and 11B illustrate yet another embodiment where the vent has a first opening within a neck 115 around the intake and the vent traverse across the proximal end of the container so that the second opening is at or about the proximal end on the opposite side of the container from the intake.

A vent can be located anywhere within a container, and can have any configuration that allows the first end to take in ambient air and the second end to expel the ambient air taken in, to reduce or eliminate gurgling and splashing when the container is emptied. Alternative vent configurations that provide the same function, in substantially the same way, with substantially the same results are within the scope of this invention.

Once a level of negative pressure has been obtained in a container, the one or more intakes must be securely closed in order to maintain the canned vacuum or suction force. The intake used for aspiration must also be opened in order to use the device. This entails being able to open and close the intake as necessary. The aspiration or vacuuming of material into the container can also be facilitated by some type of conduit 300 attached to the intake. As previously mentioned, one advantage of the embodiments of the subject invention is the ability to use a single intake 110 for the functions of a canned vacuum device of the subject invention, including but not limited to activation of the container 100, aspiration of material into the container, and elimination of material from the container. Additional intakes are certainly possible in a container of the subject invention. An intake assembly 200, however, can be used to facilitate operations with a single intake.

In one embodiment, an intake assembly 200 includes a flow control mechanism 350 which is a valve apparatus 220 operably connected to the intake. An example of this is shown in FIG. 2. A valve apparatus can also include a pressure control device 221 that can be used to mediate the negative pressure in the container, such that it allows the intake to be opened when necessary so that the negative pressure extends into the conduit, creating the vacuum force, and to be closed when the canned vacuum device 50 is not in use, in order to preserve or release the negative pressure in the container. There are numerous types of manually- or automatically-pressure control devices 221 used with valve apparatuses that can be used for these purposes. By way of non-limiting example, a valve apparatus can have any of a variety of ball valves or check-ball valves operably connected to the intake. Ball valves are used extensively in industrial applications because of their versatility, ease of repair, and simple operation. Many pressure control devices, like ball valves, can also have manual operation controllers 222 that can be used to open and close the ball valve as necessary. Ball-check valves are well-known in many industries and are versatile, have few moving parts that can break or malfunction, and are easy to use. Ball-check valves are often used with automatic control or automatic closure controls 222. There are numerous types of pressure control devices, in addition to ball valves, ball-check valves, and other types of manual or automatic valves, that can be used with the embodiments of the subject invention. Such variations, which provide the same functionality, in substantially the same way, with substantially the same result, are within the scope of the invention.

In one specific embodiment, illustrated by way of example in FIGS. 1 and 4, a ball valve apparatus 220 is removably attached to a threaded neck 115 on the intake 110. In a further embodiment, a lever 222 can be used to manually open and close the ball valve apparatus, i.e., rotate the ball valve, to mediate use of the negative pressure in the container 100. A vent, as described previously, can extend into the neck portion to expedite emptying of the container, particularly of liquids.

The aspiration or vacuuming of material into the container can be aided by the use of a conduit 300. A conduit can be used to direct the vacuum force created by the negative pressure in the container in the direction of the material to be collected. A conduit can make direct or indirect contact with the material, so that the vacuum force can pull the material into the container. It can also be important for the conduit to have sufficient tensile strength to withstand the vacuum force exerted by the negative pressure in the container. If the conduit has insufficient tensile strength, it can collapse under the vacuum force. As mentioned above, a conduit can include mechanisms or apparatuses that allow it to be attached directly to and unattached from either an intake or a neck 115 on an intake, without benefit of an intake apparatus. A conduit can also have one or more operation controllers, as discussed below, for controlling the flow of material into the container, which can, again, eliminate the need for an intake apparatus as discussed above. This can eliminate the need for an intake assembly to be utilized with a conduit. However, this does not preclude an intake assembly and an operation controller from being used together on a vacuum device embodiment.

The embodiments of a canned vacuum device 50 of the subject invention are most advantageously used with materials that inhibit the intake of ambient air. As a person with skill in the art would understand, the intake of any type of gas into a negative pressure container will reduce the level of the negative pressure, which results in a reduction in the amount of vacuum force provided by the container. For example, the embodiments disclosed here are particularly useful with liquid or viscous material, where the conduit can make direct contact with such material, so as to reduce the amount of ambient air or other gas that is taken into the container. However, the embodiments of the subject invention can also be used with any other material capable of being aspirated into the container, including gases or ambient air, if that is a desired material to collect. As will be described in detail below, a conduit can have additional valve apparatuses that can be used to inhibit or control the intake of ambient air.

A conduit 300 can comprise any of a multitude of devices or mechanisms that can be directly or indirectly attached to the container. For example, a conduit can be a flexible or semi-flexible hose, such as shown in FIG. 1, of a material having sufficient tensile strength or reinforcements along its length to inhibit collapse of the internal channel 500 when subjected to the vacuum forces of a canned vacuum device 50 of the subject invention. By way of another example, a conduit can be a rigid or semi-rigid hopper, for which an example is shown in FIG. 2, in which material can be placed or collected for aspiration into the container. It is within the skill of a person trained in the art to devise or adapt any number of devices for use as a conduit useful with the embodiments of the subject invention. Any and all such variations are within the scope of this invention.

During use of a canned vacuum device of the subject invention, the vacuum force provided by the negative pressure can be controlled with an operation controller 222 on the valve apparatus. However, it can be advantageous to have an operation controller or other mechanism on the conduit 300, particularly if the conduit is a hose or tube that allows a technician to move some distance away from the container. With this configuration, the valve control on the intake mechanism can be eliminated and the intake of material controlled entirely with the operation controller on the conduit. In one embodiment, a hose is utilized as a conduit and has a flow control mechanism 350 at some point along its length for controlling or mediating the vacuum force. FIG. 1 illustrates an example of a hose conduit having a flow control mechanism 350. In one embodiment, the flow control mechanism is a valve device that can mediate the negative pressure and thus control flow through the hose. In a more specific embodiment, the flow control mechanism can adjust the amount of vacuum force, such that it can be turned on or off and the rate of vacuum force can be adjusted as necessary. During use of a canned vacuum device 50, the valve apparatus 220 can be opened to allow negative pressure into the hose. The flow control mechanism valve can then be used to adjust the amount of vacuum force necessary at the hose tip 360 to aspirate material. It is within the skill of a person trained in the art to determine which one or more of any of a variety of flow control mechanisms to use with embodiments of the subject invention. Such variations are within the scope of this invention.

Embodiments of the subject invention that employ a smaller, portable container can be particularly useful for collecting specific types of material. For example, around the fill ports of many underground storage tanks (USTs), such as those found at most gasoline service stations, there is a sump in the ground that surrounds the fill port and is designed to catch overflow or spillage of gasoline that occurs when the UST is being filled. The U.S. Environmental Protection Agency has determined that this gasoline spillage is an environmental hazard and mandates that it must be remediated or cleaned-up regularly. The sumps can also collect water and runoff causing separation and layering of material in the sump, where the gasoline rises and layers above the water in the sump. Since it is only the gasoline that presents an immediate hazard, it can be helpful if that material can be collected immediately, and the less hazardous water pumped out or collected later. Alternatively, all of the liquid material in the sump can be collected. As mentioned above, it can also be beneficial if the amount of ambient air taken into the container during collection is minimized.

A float valve is a device that floats on top of a liquid or other flowable material and moves relative to the level of the liquid. The material around the opening causes the float valve to rise above the opening. As the liquid drains out of the opening, the float valve follows the level of the liquid until it eventually reaches the opening and blocks any further outflow. There are numerous types of float valves. Specific gravity float valves are designed to operate similarly, but usually only in the presence of a particular type of material or liquid, to which the specific gravity float valve has been calibrated.

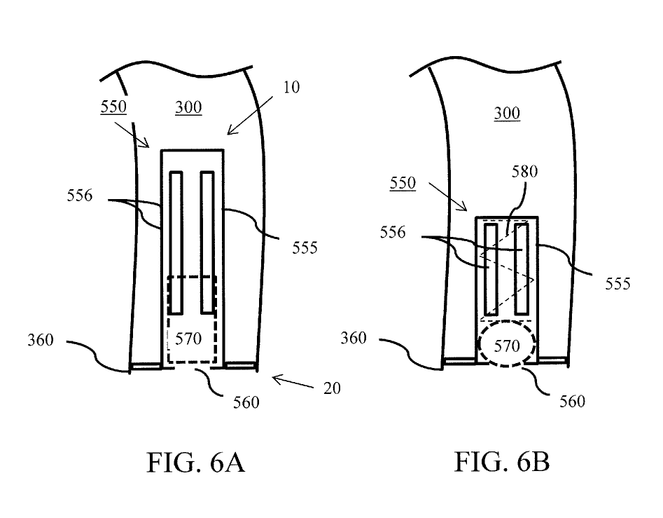

Embodiments of the subject invention that employ a hose can have a hose tip 360 that includes flow control mechanism that is a float valve assembly 550. The float valve assembly can include a perforated chamber 555 in which a float valve 570 is contained. The float valve assembly can be fixedly attached within the channel 500 of the hose conduit, with the perforated chamber 555 adequately distanced from the hose so that material can flow through the perforations 556 and into the hose channel 500. A float valve assembly can also be removeably attached, such that they can be interchangeable. The chamber can further have one or more distal end orifices 560 that can be positioned at or near the hose tip 360. FIG. 6A and 6B illustrate examples of float valve assemblies according to the subject invention. When the hose tip is placed into a flowable material, the float valve 570 can rise to the proximal end 10 of the perforated chamber, which opens the one or more distal end orifices. By maintaining the hose tip in the flowable material, the float valve 570 is pushed to the proximal end 10 in the perforated chamber and distanced from the one or more intakes, allowing vacuum force at the hose tip 360 to aspirate the flowable material into the perforated chamber and into the hose channel via the perforations 556. If the hose tip is removed from the flowable liquid or if the liquid is sufficiently reduced, the float valve will float or drop back down to the distal end 20 of the perforated chamber, blocking the one or more distal end orifices and preventing ambient air or gas from entering the distal end orifice. If a specific gravity float valve is used, then the above process will occur only if the specific gravity float is in contact with the target material(s) to which the specific gravity float valve is calibrated.

In a further embodiment, the float valve 570 can be spring-biased within the perforated chamber, which is illustrated by way of non-limiting example in FIG. 6B. A spring-bias device 580 can have a pre-determined tensile strength that can ensure that the float valve remains against the one or more distal end orifices 560 when the hose tip is not in contact with a flowable material. The spring-bias device can further allow the gravity float, or specific gravity float, to overcome the spring-bias and move to the proximal end of the chamber when the hose tip is placed in contact with the flowable material.

In yet another embodiment, the flow control mechanism 350 can be a button or extender that is spring biased against the hose tip to close off the hose tip. The button can be depressed by pushing it against the ground or other surface from which a material is to be aspirated. When the spring-biased button is depressed, by pushing the hose tip against a surface, one or more channels within the hose tip are opened to allow material on the surface to be aspirated into the container. As long as the spring-biased button is depressed against the surface, material will be aspirated. Lifting the hose tip from the surface causes the button to automatically return to the biased position, closing the hose tip, and inhibiting the intake of material or air.

In one embodiment, a conduit is operably attached to the valve apparatus, such that the intake 110, valve apparatus 200, and conduit 300 can form a contiguous channel 500, as illustrated in FIGS. 1 and 2, through which material can be taken into the container. One advantage of utilizing an operation controller 222, like a lever or dial, as shown in FIGS. 2 and 3, on the valve apparatus, as described above, is that it allows the conduit to be removable, after a container has been charged, since the operation controller can be used to close the pressure control device in the valve apparatus, sealing the container prior to the connection point of the conduit.

A conduit 300 can be operably connected or coupled to a valve apparatus 200 in several ways. The conduit can be connected directly to the valve apparatus by techniques and devices known to those with skill in the art. Such connection can be permanent to the valve apparatus or removable from the valve apparatus. Alternatively, the conduit can be connected to another device or apparatus that can then be coupled to the valve. In one embodiment, the conduit is operably connected to a cam lock 320 that can be removably coupled to the valve apparatus. Cam locks, in particular those that can be attached to a valve apparatus, are known in the art and are available in several standard sizes and categories. They often have permanently attached hoses. FIGS. 1, 2, and 3 illustrate examples of different types of hose and conduits 300 combinations that can be operably connected or coupled to a valve apparatus 110. A person with skill in the art will be able to determine an appropriate cam lock for use with the specific type of conduit and valve apparatus employed with embodiments of the subject invention.

The evacuation of air or gases from a container 100 of the subject invention is necessary in order to obtain the negative pressure required for operation. Ideally, the container can permit the evacuation of all air or gas from therein, such that there is achieved one, or approximately one, atmosphere of negative pressure in the container, without the container collapsing or at least not being detrimentally deformed. As material is drawn into the container, it occupies a volume in the container. Assuming that the amount of ambient air taken into the container with the material is minimized, the container will maintain all or most of the negative pressure at or about one atmosphere. Intake of ambient air can reduce the level of negative pressure, which can reduce the vacuum force; but, the canned vacuum device of the subject invention can still operate below one atmosphere to aspirate material.

Pumps 600 of numerous configurations can be used to evacuate a container 100 of the subject invention. Any pump capable of being cooperatively attached to the container of a canned vacuum device 50 of the subject invention and used to evacuate the gas(es) therein would be appropriate with the embodiments of the subject invention. This can include the pump being attachable to or integrated with any component of the intake assembly 200 or the conduit 300. It can be preferable for a pump to be cooperatively attached to the proximal end 10 of the valve apparatus 200. As discussed above, the valve apparatus can have a manual or automatic mechanism that can close the valve, sealing the intake, and maintaining any negative pressure therein once the container has been fully or partially evacuated. A pump can be attached directly to the valve apparatus, as shown in the example in FIG. 5, or it can be attached to any other component of the intake assembly. If necessary, a pump can also be connected to a conduit 300, such as the distal end of the conduit and the container evacuated through the conduit.

A pump can be a separate device to which a canned vacuum device 50 can be attached. Thus, the vacuum device can be separated from the pump and the canned vacuum device transported to and utilized at another location without the pump. FIG. 5 illustrates an example of a separate pump being operatively attached directly to a valve apparatus, such that the pump can be disconnected when no longer needed.

Alternatively, a pump can be incorporated with, stored with, or attached to a canned vacuum device of the subject invention, such that the pump is not separated from the canned vacuum device can be readily available to evacuate the container. With this embodiment, the pump can be used wherever the container is taken, so as to recharge the container with a negative pressure.

In one embodiment, the container 100 has a compartment 150, such as, for example, on the distal end, in which a pump, such as, by way of non-limiting example, an electric or venturi pump 600, can be stored. Access openings 155 in the compartment can provide access to the storage container interior and the components of the pump that are required to evacuate a container, such as an electrical connection 620 and a hose 640 for connecting to the intake assembly 200 or conduit 300 or to make repairs. There can also be one or more portals 157 through which an air hose or electric cord can be inserted to attach to a pump and/or for the exit of air or exhaust from a pump.

In one embodiment, the conduit 300 can be utilized as a connection to the pump, such that the pump does not require its own hose. With this embodiment, the hose tip can be operatively attached to the pump through the access opening or a portal for evacuating air from the container. FIG. 4A illustrates an example of a container with a pump in a storage compartment 150 and dual access openings 155. FIGS. 11A and 11B illustrate an embodiment of a container with a pump in a storage compartment on the container, where the storage compartment has dual portals. A variety of access ports and portals can be used with the container embodiments and storage compartments of the subject invention. Such variations are within the scope of this invention.

In a further embodiment, there can be one or more connectors 160 on or in a portal, that allows an external electric, compressed air, carbon fuel, water, or other source of operational energy to be sent to the pump within the compartment without utilizing an access opening 155 or having to insert a hose or tube into the storage compartment. A connector can be any of a variety of mechanisms, including, but not limited to, any of a variety of quick connectors or exhaust valves, and the appropriate connector will depend upon the type of pump used with and/or stored within the compartment. This represents just one example of how an electric or other type of pump could be incorporated with a canned vacuum device of the subject invention. Alternative configurations will be apparent to a person skilled in the art. Such variations are within the scope of this invention.

In another embodiment, the container has incorporated therein an evacuation channel 130 which has a pump port 132. The pump port can open at or about the distal end 20 and can further open into the pump compartment 150 and an evacuation port 134 at or about the proximal end 10 of the container. The pump within the dedicated compartment 150 can be attached to the pump port, so as to evacuate air from the container through the evacuation port. Embodiments that do not have a dedicated pump compartment can have the pump port lead to any location, including the distal end, on the outside of the container. As will understood below, the pump port can be closed when not in use. Having the evacuation port located near the proximal end allows the container to be evacuated of air even if there is aspirated material already in the container. FIGS. 4B and 4D illustrate one embodiment of a container 100 with an evacuation channel. The evacuation channel can be located in any of a variety of locations on a container, as long as the pump port can be operably connected to a pump and, ideally, the evacuation port is located above the fill line in the container.

In a particular embodiment, the evacuation port is positioned so that when the container is filled or emptied, fluid or other material is directed away from the evacuation port. This can inhibit material from being collected in the evacuation channel and accidentally carried to the pump. For example, if the intake 110 is located along the side of the proximal end, an example of which is shown in FIGS. 4C-4E, the evacuation channel can be positioned with the evacuation port directed to the proximal end of the container and as far as feasibly possible from the intake. FIGS. 4C-4E show an evacuation channel that is substantially vertical, with the evacuation port vertically aligned with the pump port when the container is sitting. Alternative embodiments can have an evacuation channel that is angled or curved, such that the pump port is not vertically aligned with the evacuation port when the container is sitting. An example of this embodiment is not shown in the figures, but is readily understood by a person with skill in the art.

In another particular embodiment, the pump port is operably connected to a pump disposed within a pump compartment 150 in the container. In one embodiment, the pump and compartment are located at or about the distal end of the container, non-limiting examples of which are shown in FIGS. 4A-4E. The pump can be operably connected at all times to the pump port on the evacuation channel. This can eliminate the need to attach a separate hose or conduit to the pump in order to evacuate the container. Whenever the negative pressure needs to be restored or refreshed in the container 100, the pump can be turned on or activated and the negative pressure restored through the evacuation channel. This can make the canned vacuum device even more portable, as it can be used and refreshed in any location.

The pump can also be reversible, such that air can be forced into the container. This can be advantageous in the event that material was accidentally introduced into the evacuation channel. The pump can be used to force out the material and then used to restore the negative pressure in the container.

In a further embodiment, the evacuation channel can have a closure mechanism so that the negative pressure can be maintained when or if the pump is disconnected. This can include any of a variety of plugs, doors, automatic mechanisms, and other devices known in the art. It can also include a valve that can close the evacuation channel when the pump is not in use. In one embodiment, a one-way valve can be used in the pump port 132, such as, for example, a Schrader or American valve. The pump can be connected to the one-way valve. Alternatively, if the pump is reversible, as mentioned above, a two-way or reversible valve can be used, so that air can be moved in both directions within the evacuation channel.

The canned vacuum device embodiments of the subject invention are particularly useful for field use in areas where electricity is not available or easily accessed. They are also particularly useful in situations where small amounts of material may have to be collected at multiple locations. For example, the fill ports of underground storage tanks, described above, often have small amounts of petroleum product to be collected at several different sites. The embodiments of the subject invention provide a safe, convenient way to aspirate or vacuum this hazardous spillage in the field and at numerous sites without using electrical power, which can be difficult to access and cause an ignition of the volatile gases. However, the very lack of access to electrical power in the field can make it difficult to charge a container in the field.

A venturi pump is a unique type of pump designed to operate by the action of compressed air moving through chambers, which creates a “venturi vacuum effect.” In a typical venturi pump, compressed air is forced through a first chamber and through a smaller portal that opens into a second chamber that is larger than the first chamber. The air expands as it passes into the larger container producing a negative pressure area 670 right at the portal area. A vacuum port 675 can be positioned advantageously at the point where the negative pressure area is created.

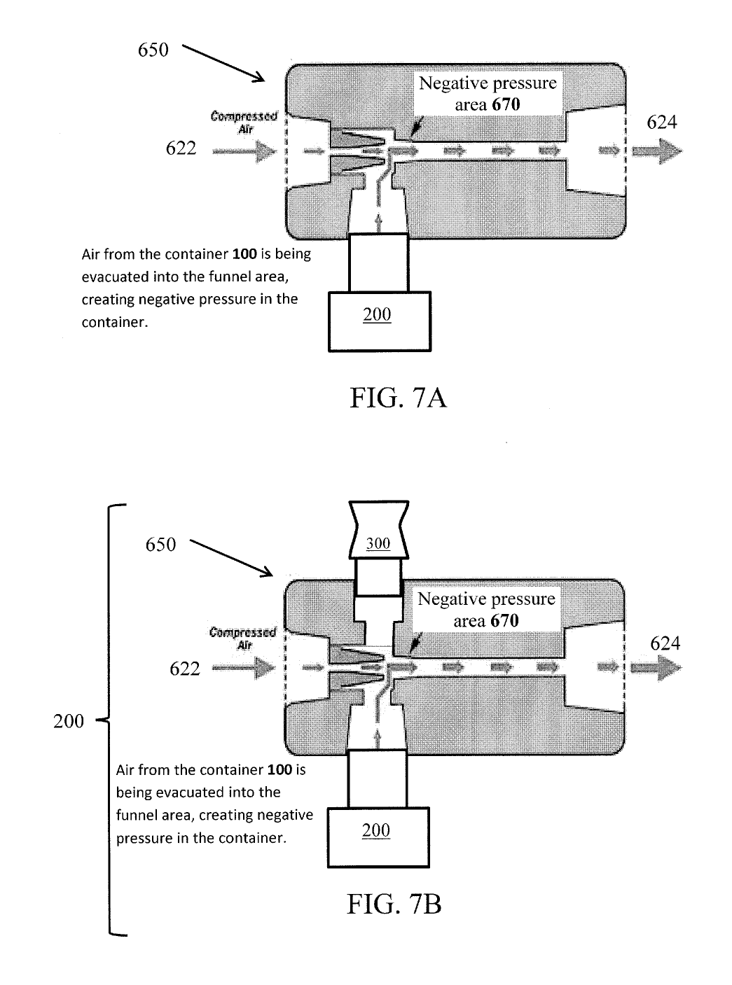

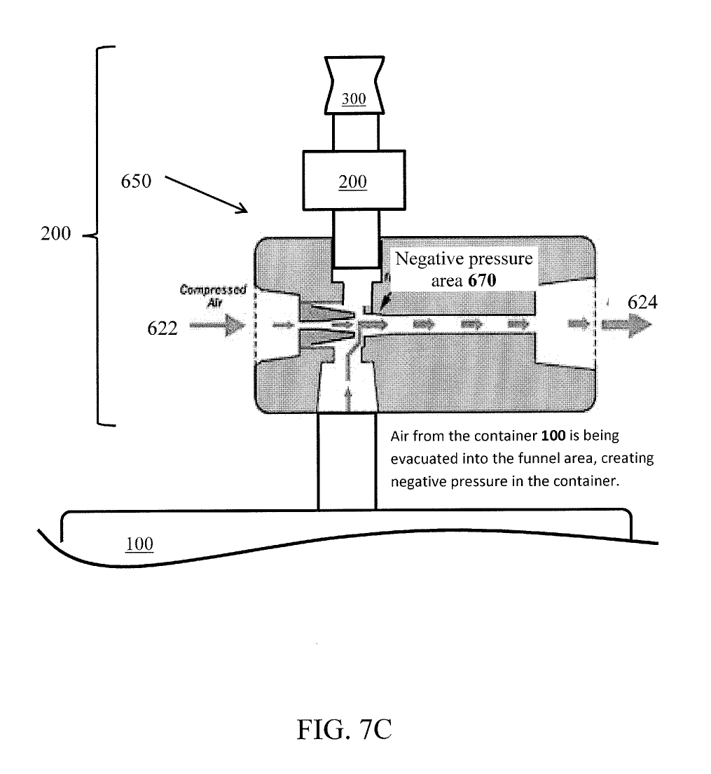

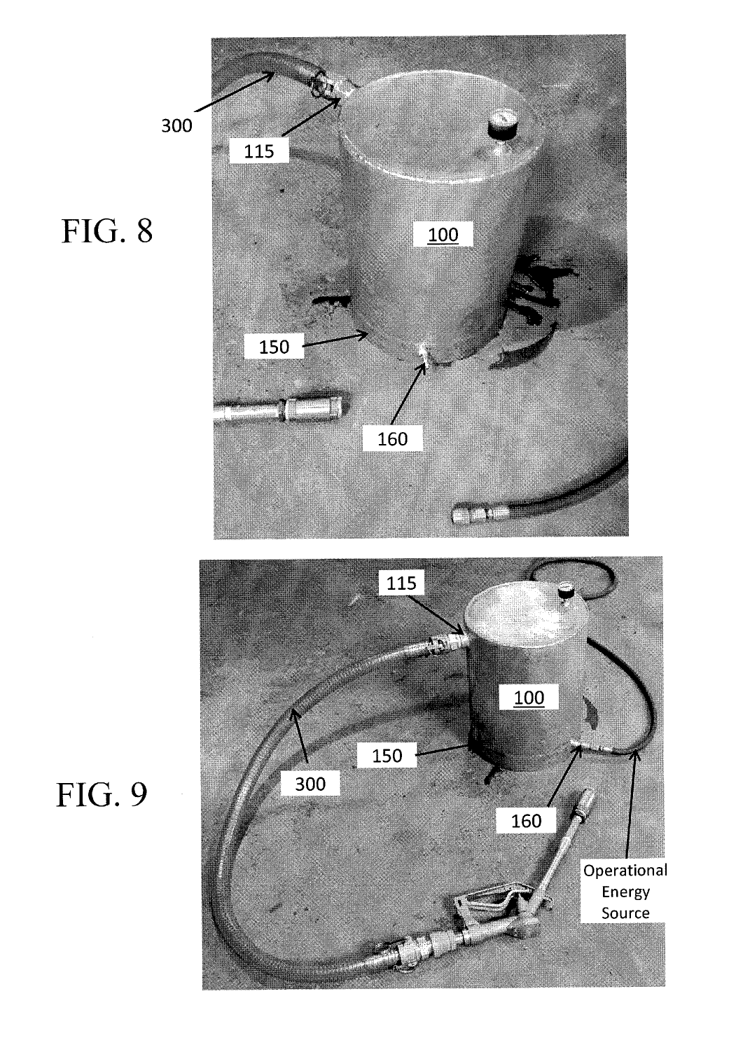

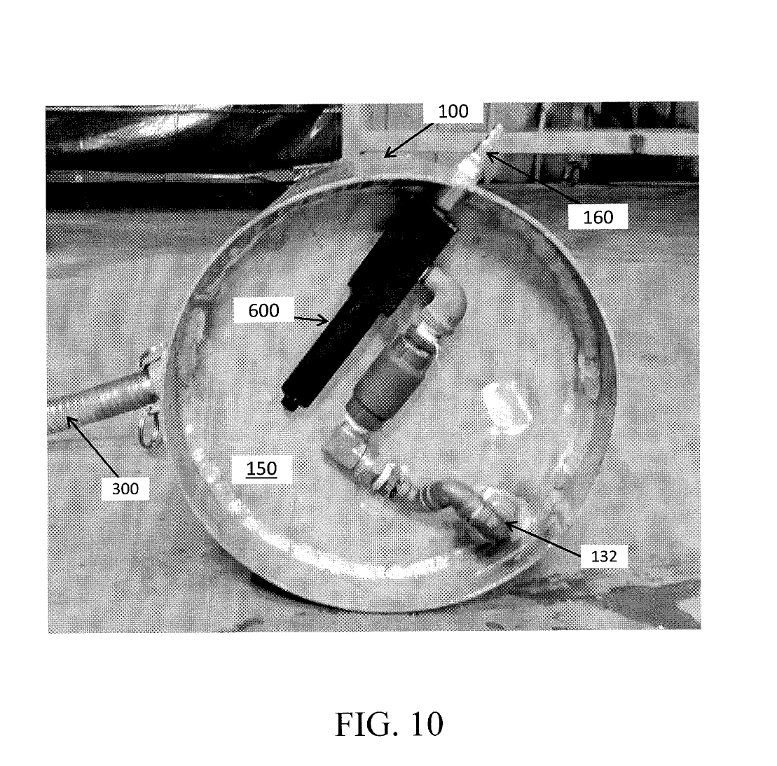

When the venturi pump is in operation, air or gas can be pulled through the vacuum port due to the negative pressure at the portal area. FIGS. 7A and 7B, which will be discussed below, provide illustrations of this effect. Venturi pumps can produce a negative pressure in a container of up to about 28.5″ of mercury, which is less than a full atmosphere, but still sufficient for aspiration of most materials.

In a particular embodiment, a canned vacuum device 50 of the subject invention is adapted to have a venturi pump 650. A venturi pump can provide the same or similar functions as an electric pump and can be operated in the same fashion as any other pump 600, in the embodiments described above. A venturi pump can be operably connected to the intake assembly 200 and/or the conduit 300. In one embodiment, a venturi pump can be cooperatively connected to the valve apparatus. With this embodiment, the conduit can be temporarily removed from the valve apparatus. The venturi pump can be affixed to the valve apparatus, which can be opened, and the venturi pump operated to evacuate the container, which is attached to the vacuum. One example of this is shown in FIG. 7A.

In an alternative particular embodiment, a canned vacuum device 50 of the subject invention is adapted to have a venturi pump 650 incorporated as part of the intake assembly 200. With this embodiment, a venturi pump can be operatively connected between two of the components of the valve assembly. For example, FIG. 7B illustrates an embodiment where the venturi pump can be operatively connected between the valve apparatus 200 and the cam lock 320 that attaches to the conduit 300. This can necessitate the cam lock and/or the conduit having a closure mechanism. Otherwise, air from the conduit can be drawn into the negative pressure area 670, preventing or inhibiting air from being evacuated from the container. In an embodiment discussed above, the conduit can have a flow control mechanism 350 that closes the conduit.

In an alternative example, the venturi pump can be operatively connected between the container and the valve apparatus. With this embodiment, the venturi pump can be operated with the cam lock/conduit and valve apparatus remaining in place on the container, but does not require the cam lock or conduit to have a closure mechanism, since the valve apparatus can assume the function of closing off the conduit. FIG. 7C illustrates one example of such an embodiment. The compressed air intake 652 and compressed air exit 654 can be plugged, capped, or otherwise sealed, when the venturi pump is not in use.

In yet another embodiment, a venturi pump can be configured within the dedicated compartment 150. With this embodiment, the access opening can be used to attach the air hose to the venturi pump. Alternatively, there can be one or more connectors on the outside of the compartment for operatively connecting an air hose or other air source to the venture pump. A person with skill in the art, having benefit of the subject disclosure, would be able to determine any number of ways to configure a venturi pump or any other type of pump within a compartment 150 for evacuation of air from a container 100. Such variations are within the scope of this invention.

The scope of the invention is not limited by the specific examples and suggested procedures and uses related herein since modifications can be made within such scope from the information provided by this specification to those skilled in the art.

The examples and embodiments described herein are for illustrative purposes only and that various modifications or changes in light thereof will be suggested to persons skilled in the art and are to be included within the spirit and purview of this application.

Any reference in this specification to “one embodiment,” “an embodiment,” “example embodiment,” “further embodiment,” “alternative embodiment,” etc., is for literary convenience. The implication is that any particular feature, structure, or characteristic described in connection with such an embodiment is included in at least one embodiment of the invention. The appearance of such phrases in various places in the specification does not necessarily refer to the same embodiment. Further, when a particular feature, structure, or characteristic is described in connection with any embodiment, it is within the purview of one skilled in the art to affect such feature, structure, or characteristic in connection with other ones of the embodiments.

The invention has been described herein in considerable detail, in order to comply with the Patent Statutes and to provide those skilled in the art with information needed to apply the novel principles, and to construct and use such specialized components as are required. However, the invention can be carried out by specifically different equipment and devices, and that various modifications, both as to equipment details and operating procedures can be effected without departing from the scope of the invention itself. Further, although the present invention has been described with reference to specific details of certain embodiments thereof and by examples disclosed herein, it is not intended that such details should be regarded as limitations upon the scope of the invention except as and to the extent that they are included in the accompanying claims.

We claim:

1. A vacuum device comprising:
a container having a proximal end and a distal end, where the container maintains a negative pressure of up to one atmosphere, and further has,
an intake at or near to the proximal end, and
a vent within the container having a first opening in an operable position at or near to the intake and a second opening further within the container;
an evacuation channel within the container having a pump port adapted to be connected to a pump for evacuating air from the container and an evacuation port located within the container,
a conduit operably connected to the intake that is used to aspirate material into the container.

2. The vacuum device according to claim 1, wherein the conduit is a hose.

3. The vacuum device according to claim 1, further comprising at least one flow control mechanism on at least one of the conduit, the intake, and a tip on the hose.

4. The vacuum device according to claim 1, wherein the vent is removably attached to the container interior.

5. The vacuum device according to claim 1, wherein at least a portion of the evacuation channel is attached to a wall of the container.

6. The vacuum device according to claim 3, further comprising a storage compartment operably attached to the container.

7. The vacuum device according to claim 6, further comprising at least one of an access opening and a portal within the storage compartment.

8. The vacuum device according to claim 7, wherein a pump port of the evacuation channel opens into the storage compartment.

9. The vacuum device according to claim 8, further comprising a pump within the storage compartment and operably connected to the pump port.

10. The vacuum device according to claim 9, wherein the pump is a venturi pump.

11. The vacuum device according to claim 9, further comprising a connector on the at least one portal.

12. A method for remediating a material, utilizing a vacuum device according to claim 1, wherein the method comprises:
evacuating air or gas from the container utilizing the evacuation channel, to create a negative pressure in the container;
contacting the material to be remediated with the conduit;
aspirating the material into the container through the conduit;
removing the conduit from the intake; and
pouring the remediated material in the container out of the intake.

13. The method according to claim 12, wherein the vacuum device further comprises a flow control mechanism on the conduit, and wherein the method further comprises utilizing the flow control mechanism to open the conduit prior to aspirating the material.

14. The method according to claim 13, wherein the vacuum device further comprises a pump attached to the pump port on the evacuation channel, and wherein the method further comprises activating the pump to evacuate the container and reactivating the pump after aspirating material to restore negative pressure in the container.

15. The method according to claim 14, wherein the pump comprises a venturi pump.

16. The method according to claim 15, wherein the vacuum device further comprises a storage compartment on the container in which the venturi pump is disposed.

17. The method according to claim 16, wherein the vacuum device further comprises a connector on the storage compartment in operably connection with the pump, and wherein the method further comprises activating the pump by utilizing the connector.

18. A kit for remediating a volatile material, the kit comprising:
a vacuum container according to claim 1;
a pump attachable to the pump port of the evacuation channel; and
a source of operational energy attachable to the pump.

19. The kit according to claim 18, wherein the pump is a venturi pump and the source of operational energy is an air compressor.

20. The kit according to claim 19, further comprising a storage compartment on the container in which the venturi pump is disposed.
